(19) United States
(12) Patent Application Publication
(10) Pub. No.: US 2013/0329461 A1
(43) Pub. Date: Dec. 12, 2013

(54) POWER SUPPLY DEVICE USING ELECTRIC POWER NETWORK

(71) Applicants: SHIH-PO LO, NEW TAIPEI CITY (TW); TAN-LUNG CHEN, NEW TAIPEI CITY (TW)

(72) Inventors: SHIH-PO LO, NEW TAIPEI CITY (TW); TAN-LUNG CHEN, NEW TAIPEI CITY (TW)

(73) Assignee: ASKEY COMPUTER CORP.

(21) Appl. No.: 13/584,907

(22) Filed: Aug. 14, 2012

(30) Foreign Application Priority Data
Jun. 7, 2012 (TW) 101211007

(51) Int. Cl. H02M 7/02

(52) U.S. Cl. 363/13

(57) ABSTRACT

A power supply device using electric power network connects to an external power source and an electronic device, and supplies an alternating current power from the external power source to the electronic device to be a direct current power for the electronic device. In this case, the power supply device using electric power network comprises an electric power connection unit connected with the external power source, a conversion unit connected with the electric power connection unit, and an output unit connected with the conversion unit and the electronic device. The electric power connection unit is used for acquiring the alternating current power from the external power source, and the alternating current power is converted into a direct current power by the conversion unit. Thereby, the direct current power required for the electronic device during the process of charging and supplying power is supplied.

### CROSS-REFERENCE TO RELATED APPLICATION

This non-provisional application claims priority under 35 U.S.C. §119(a) on Patent Application No(s). 101211007 filed in Taiwan, R.O.C. on Jun. 7, 2012, the entire contents of which are hereby incorporated by reference.

### FIELD OF TECHNOLOGY

The present invention is related to a power supply device, particularly to a power supply device using electric power network supplying direct current power to an electronic device in need during the process of charging and supplying power.

### BACKGROUND

In conventional technology, a traditional power supply device using electric power network (home plug) is allowed for an electronic device to connect to the Internet through an electric power circuit having a socket, in which the socket is provided with a plurality of holes.

The power supply device using electric power network is, however, considerably bulky, in such a way that at least one of the holes may be occupied by the power supply device using electric power network when this power supply device using electric power network is mounted to the socket. Thus, although the socket may be provided for the electronic device to connect to the Internet, the possibility for other electronic devices to acquire electric power from the electric power circuit after it is inserted into the hole may be reduced.

In particular, numerous electronic devices are rife at present. If connecting several electronic devices to several holes of identical socket at the same time to charge and supply power, while connecting them to the Internet is desired by a user, the above-mentioned problem could not be solved effectively by the traditional electric power circuit device.

Additional numerous relevant electric power extension equipments, such as one-to-many socket, for example, to increase the number of holes is exceptional. Additional cost, however, is required for the added electric power extension equipment.

Furthermore, additional purchase of a transformer for electronic device is generally required when the electronic device is powered. One hole, however, is still occupied perpetually by the transformer, in such a way that not only the additionally added exclusive transformer is required, but also the additional electric power extension equipment is possibly required for the electronic device.

Even if a plurality of holes are provided in the socket, in addition, it is extremely hard to insert the electric power circuit device and the transformer at the same time into an ordinary multi-hole socket having an extremely narrow interspace between adjacent two holes, owing to an exterior case of the transformer having a certain volume and an exterior case of the electric power circuit device having a certain volume similarly.

Therefore, the present invention provides a power supply device using electric power network capable of solving above-mentioned drawbacks.

### SUMMARY

It is one object of the present invention to provide a power supply device using electric power network used for supplying a required direct current power to an electronic device, so as to achieve the object of charging and supplying power to the electronic device.

For achieving above object, the present invention provides a power supply device using electric power network provided for connecting to an external power source and an electronic device, the power supply device using electric power network comprising an electric power connection unit, a conversion unit and an output unit. In this case, the electric power connection unit is provided for connecting with the external power source and used for receiving an alternating current power transmitted therefrom. The conversion unit is connected with the electric power connection unit, and used to convert the alternating current power into a direct current power. Moreover, the output unit is connected with the conversion unit and the electronic device, as well as used to output the converted direct current power from the conversion unit to the electronic device.

In comparison with the conventional technology, the power supply device using electric power network of the present invention is allowed to, in addition to providing the connection of the electronic product to the Internet by means of the external power source and supplying alternating current power to the electronic product in need, supply required direct current power to the electronic device directly, in which the direct current power comes from the alternating current power (such as 110V or 220VAC mains, for example) acquired from the external power source, said alternating current power being then converted by the power supply device using electric power network directly into an output of the direct current power (such as voltage of 5VDC, for example), as required by the electronic device.

In other words, the power supply device using electric power network of the present invention may be used to convert the received alternating current power directly without the need for additional purchase of a transformer. Moreover, loss of one hole, capable of supplying power, due to the use of traditional power supply using electric power network, may not occur, as well as the drawback of incapability of providing the power supply device using electric power network and the transformer into the socket at the same time may be avoided.

Furthermore, the power supply device using electric power network may be allowed for not only connecting to the Internet and supplying alternating current power, but also supplying direct current power to the electronic device or other electronic devices to charge and supply power.

### BRIEF DESCRIPTION OF THE DRAWINGS

FIG. 1 is a block diagram of a power supply device using electric power network according to one first embodiment of the present invention;

FIG. 2 is a block diagram of a power supply device using electric power network according to one second embodiment of the present invention; and

FIG. 3 is a block diagram of a power supply device using electric power network according to one third embodiment of the present invention.

### DETAILED DESCRIPTION

A detailed description will be made to the present invention by means of following embodiments in cooperation with accompanied drawings for fully understanding the objects, features and effects of the present invention.

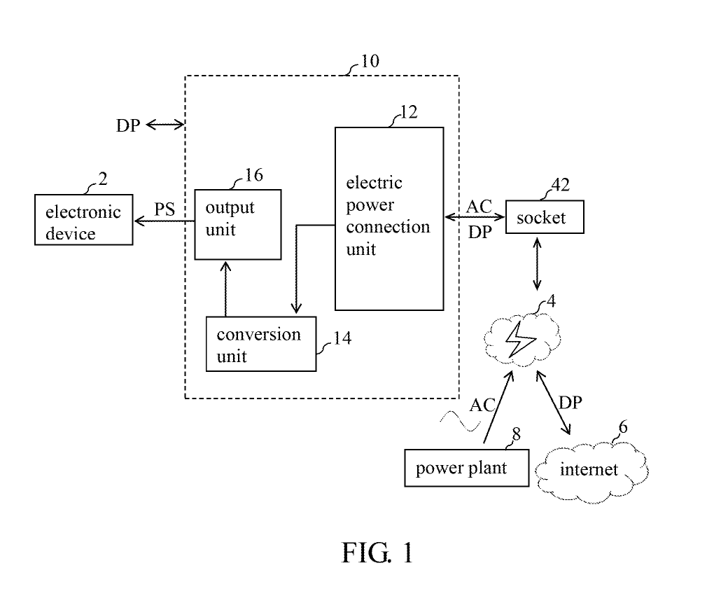

Referring to FIG. 1, there is shown a block diagram of a power supply device using electric power network according to one first embodiment of the present invention. In FIG. 1, the power supply device using electric power network 10 is provided for connecting to an external power source 4 and an electronic device 2, as well as supplying an alternating current power AC (Alternating Current), provided by the external power source 4, to the electronic device 2 to be a direct current power PS (Power Supply) for the electronic device 2.

Furthermore, the power supply device using electric power network 10 may be also a network device for data transmission by the use of data package (DP) (as detailed in the later embodiment). Here, the data package DP is used to illustrate that the direct current power PS is supplied by the power supply device using electric power network 10, while data transmission by means of the data package DP is also carried out thereby, in such a way that the data package DP is sent to an Internet 6 through the power supply device using electric power network 10, or received from the Internet 6 by the power supply device using electric power network 10. In this case, the alternating current power AC may be supplied by the external power source 4 through a socket 42, for example. In addition, the power supply device using electric power network 10 may further comprise a socket (not shown in the figure), by which the alternating current power AC is provided to an electronic device in need (not shown in the figure).

Furthermore, the electronic device 2 is a portable mobile device, desktop computer, notebook, smart appliance and etc. However, the alternating current power AC (such as 110V or 220VAC mains) is received from a power plant 8 by the external power source 4. For instance, the alternating current power AC of the external power source 4 is transmitted through twisted pair cables. Here, the alternating current power AC of a sine wave is taken as an example.

For instance, the power supply device using electric power network 10 is connected to the external power source 4 through the socket 42, and the external power source 4 is provided with the alternating current power AC. When the power supply device using electric power network 10 is inserted into the socket 42, the alternating current power AC is received by the power supply device using electric power network 10 through the socket 42, and the received alternating current power AC is converted into the direct current power PS by the power supply device using electric power network 10 to be supplied to the electronic device 2.

In this case, the power supply device using electric power network 10 comprises an electric power connection unit 12, a conversion unit 14 and an output unit 16.

The electric power connection unit 12 is provided to be connected to the external power source 4, and is used to receive the alternating current power AC transmitted from the external power source 4. In this case, the electric power connection unit 12 may be presented in the form of a plurality of pins cooperated with the socket 42, such that the pins, the amount of which is 2 or 3, for example, are inserted into the socket 42.

The conversion unit 14 is connected with the electric power connection unit 12 to receive the alternating current power AC, and convert the received alternating current power AC into the direct current power PS. Here, the conversion unit 14 is allowed to convert the alternating current power AC into the direct current power PS, namely, the alternating current power AC is converted into the direct current power PS by way of electric power modulation, such as voltage reduction, rectification and filtration, for example. For instance, the direct current power PS is at voltage of 5VDC.

The output unit 16 is connected with the conversion unit 14, and is used to output the direct current power PS to the electronic device 2. The output unit 16 may be an electrical connector conforming to Universal Serial Bus (USB), Mini USB or Micro USB.

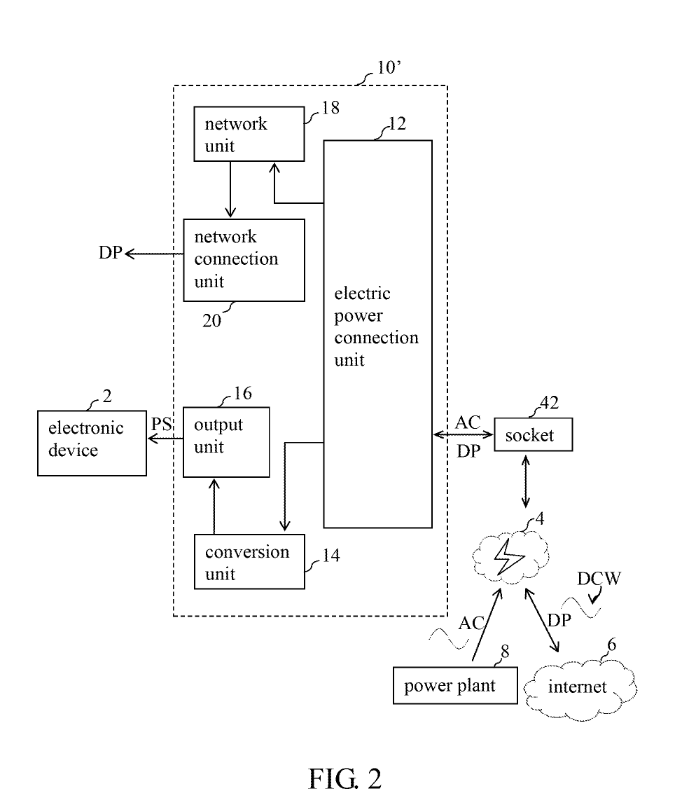

Referring to FIG. 2, there is shown a block diagram of a power supply device using electric power network according to one second embodiment of the present invention. In FIG. 2, the power supply device using electric power network 10′ is similarly connected to the external power source 4 and the electronic device 2. In this case, the external power source 4 may be presented as the socket 42, for example, capable of supplying the alternating current power AC, which is outputted to the electronic device 2 to supply the direct current power PS to the electronic device 2 in need, when the external power source 4 and the power supply device using electric power network 10′ are combined. Furthermore, the power supply device using electric power network 10′ may be also provided for the connection of the electronic device 2 to the Internet 6 through the external power source 4.

In detail, the operation of the connection of the electronic device 2 to the Internet 6 through the external power source 4 is data carried wave (DCW) transmission carried out by the power supply device using electric power network 10′ by means of the external power source 4. In addition, the connection with a gateway (not shown in the figure) is further used by the power supply device using electric power network 10′, such that the data carried wave DCW may be transmitted to the Internet 6 through the gateway. In other words, the power supply device using electric power network 10′ is allowed to carry out bi-directional data transmission of data package DP by means of the data carried wave DCW in said external power source, in which the DP is presented in the form for data transmission on the Internet 6. In addition, the data package DP is also transmitted among the electronic device 2, the external power source 4 and the power supply device using electric power network 10′.

Namely, the power supply device using electric power network 10′ is connected to the external power source 4 through the socket 42, such that the power supply device using electric power network 10′ is allowed to not only transmit the data package DP by means of the data carried wave DCW in the external power source 4, but also convert the alternating current power AC into the direct current power PS.

In this connection, the description of supplying the direct current power PS of the power supply device using electric power network 10′ is similar to that of converting the alternating current power AC into the direct current power PS provided for the electronic device 2 by means of the electric power connection unit 12, the conversion unit 14 and the output unit 16 in the first embodiment. In this case, the direct current power PS may be provided for the electronic device 2 to charge or to supply power.

Furthermore, bi-directional data transmission between the electronic device 2 and the Internet 6 is provided by the power supply device using electric power network 10′. In this case, the power supply device using electric power network 10′ further comprises a network unit 18 and a network connection unit 20.

The power supply device using electric power network 10′ is connected to the external power source 4 through the electric power connection unit 12 when the electric power connection unit 12 is inserted into the socket 42.

The network unit 18 is connected with the electric power connection unit 12, and is used to process the data package DP. Here, the network unit 18 may comprise a digital-to-analogue conversion unit, analogue-to-digital conversion unit, encoding unit, decoding unit and etc. (not shown in the figure), used for acquiring the data package DP from the data carried wave DCW.

The network connection unit 20 is connected with the network unit 18, and is provided for any device (not shown in the figure), required to be connected to the Internet 6, to connect to the Internet therethrough, in such a way that the data package DP acquired from the network unit 18 by any device or the data package DP generated by any device and then allowed to pass though the network connection unit 20 is transmitted to the Internet 6 by the network unit 18. In this case, the network connection unit 20 is a slot of type RJ-45, and the any device may be connected through a network connection plug of type RJ-45.

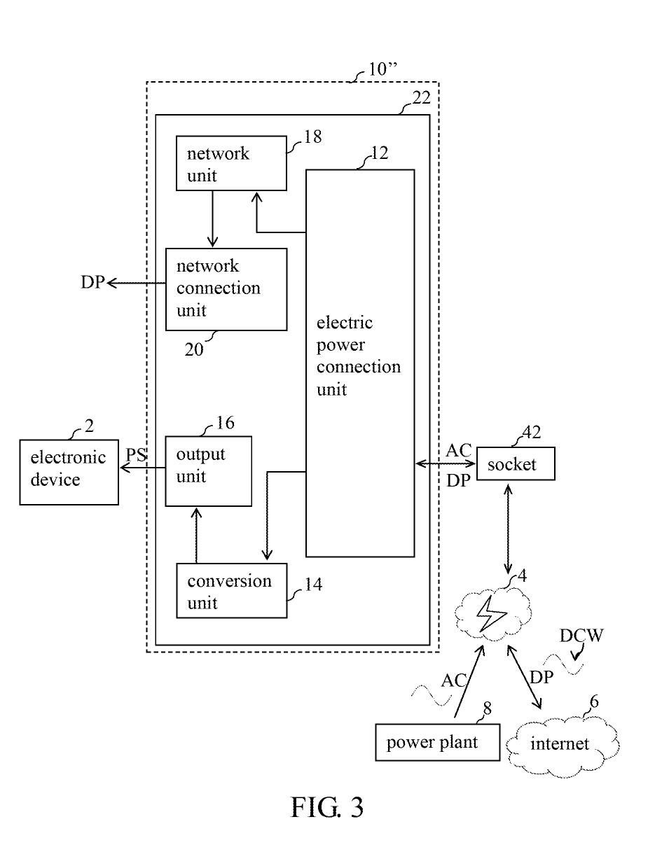

Referring to FIG. 3, there is shown a block diagram of a power supply device using electric power network according to one third embodiment of the present invention. In FIG. 3, the power supply device using electric power network 10″ further comprises a case body 22, in addition to the electric power connection unit 12, the conversion unit 14, the output unit 16, the network unit 18 and the network connection unit 20 described in the first embodiment. In this connection, the case body 22 is further provided with a plurality of openings (not shown in the figure). The electric power connection unit 12, the network unit 18, the network connection unit 20, the conversion unit 14 and the output unit 16 are accommodated within the case body 22, while the electric power connection unit 12, the network connection unit 20 and the output unit 16 may be appeared out of the case body 22 through these openings.

The power supply device using electric power network of the present invention may provide not only the connection of the electronic device to the Internet by means of the external power source and supplying alternating current power to the electronic product in need, but also the effect of converting alternating current power into direct current power directly. In other words, no additional voltage converter must be purchased additionally to convert electric power for the electronic device, and loss of one plug, capable of supplying electric power, due to the use of traditional power supply using electric power network may not occur.

The present invention is disclosed by embodiments in foregoing description. However, it should be understood by those skilled in the art that the embodiments are merely used for describing the present invention and not considered as restrictive. It should be noted, that all equivalent variations and substitutions may be included within the scope of the present invention. Therefore, the present invention to be protected should be defined by appended claims.

What is claimed is:

1. A power supply device using electric power network provided for connecting to an external power source and an electronic device, said external power source being used for supplying an alternating current power, said power supply device using electric power network comprising:
an electric power connection unit, provided for connecting with said external power source and used for receiving said alternating current power transmitted therefrom;
a conversion unit, connected with said electric power connection unit, and used to convert said alternating current power into a direct current power; and
an output unit, connected with said conversion unit and said electronic device, as well as used to output said direct current power to said electronic device.

2. The power supply device using electric power network according to claim 1, wherein said electric power connection unit is presented as a plurality of pins, and said pins are inserted into a socket.

3. The power supply device using electric power network according to claim 2, wherein the amount of said pins is 2 or 3.

4. The power supply device using electric power network according to claim 2, wherein said output unit is presented in the form of an electrical connection port conforming to specification of Universal Serial Bus (USB), Mini USB or Micro USB.

5. The power supply device using electric power network according to claim 1, further comprising a case body provided with a plurality of openings, said case body being accommodated with said electric power connection unit, said conversion unit and said output unit, said electric power connection unit and said output unit being appeared out of said case body through said openings.

6. The power supply device using electric power network according to claim 1, wherein said direct current power is at voltage of 5V.

7. The power supply device using electric power network according to claim 1, further comprising a network unit and a network connection unit, used for providing the connection to the Internet.

8. The power supply device using electric power network according to claim 1, further comprising a socket, used for providing said alternating current power.
